(19) United States
(12) Patent Application Publication
(10) Pub. No.: US 2015/0311926 A1
(43) Pub. Date: Oct. 29, 2015

(54) Acquisition of Nonlinearity in Electronic Communication Devices

(71) Applicant: MagnaCom Ltd., Petach Tikva (IL)

(72) Inventors: Amir Eliaz, Moshav Ben Shemen (IL); Ilan Reuven, Ganey Tikva (IL)

(21) Appl. No.: 14/659,797

(22) Filed: Mar. 17, 2015

Related U.S. Application Data
(60) Provisional application No. 61/985,586, filed on Apr. 29, 2014.

(51) Int. Cl. H04B 1/04

(52) U.S. Cl. CPC H04B 1/0475; H04B 2001/0425

(57) ABSTRACT

Circuitry of an electronic transmitter may determine characteristics of nonlinear distortion introduced by the electronic transmitter during transmission of electronic signals onto a communication medium, and transmit a training signal, from which the characteristics of the nonlinear distortion can be recovered, prior to transmitting data onto the communication medium. The circuitry may transmit the training signal as part of a preamble of each burst of data transmitted by the circuitry of the electronic transmitter. The circuitry may transmit the training signal as part of a handshaking protocol used for admission of the electronic transmitter to a network. The circuitry may transmit the training signal in response to a request from receiver. The characteristics of the nonlinear distortion comprise an indication of a type of nonlinear distortion model suited for replicating the nonlinear distortion introduced by the electronic transmitter.

### CLAIM OF PRIORITY

This patent application makes reference to, claims priority to and claims the benefit from U.S. Provisional Patent Application Ser. No. 61/985,586, filed Apr. 29, 2014, which is incorporated herein by reference in its entirety.

### INCORPORATION BY REFERENCE

Each of the following applications is hereby incorporated herein by reference:

U.S. provisional patent application Ser. No. 61/929,679 titled “Communication Methods and Systems for Nonlinear Multi-User Environments;”
U.S. patent application Ser. No. 14/600,310 titled “Communication Methods and Systems for Nonlinear Multi-User Environments;”
U.S. provisional patent application Ser. No. 61/875,174 titled “Adaptive Nonlinear Model Learning;”
U.S. provisional patent application Ser. No. 14/481,108 titled “Adaptive Nonlinear Model Learning;”
U.S. Pat. No. 8,737,458 titled “Highly-Spectrally-Efficient Reception Using Orthogonal Frequency Division Multiplexing;” and
U.S. Pat. No. 8,582,637 titled “Low-Complexity, Highly-Spectrally-Efficient Communications.”

### BACKGROUND

Conventional communications systems suffer from degraded performance in the presence of nonlinear distortion. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for acquisition of nonlinearity in electronic communication devices, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating communication devices operable to perform nonlinearity estimation/replication for processing of received signals.

FIG. 2A shows a flowchart illustrating an example network admission and nonlinear distortion acquisition process used by the communication devices of FIG. 1.

FIGS. 2B and 2C show a particular example implementation of the flowchart of FIG. 2A.

FIG. 3 is a flowchart illustrating an example process performed by devices operable to perform nonlinear distortion estimation/replication for processing of received signals.

FIG. 4 is a flowchart illustrating example operations in which nonlinear distortion models are trained on a per-burst basis using preambles of the data bursts.

FIGS. 5A-5C illustrate example formats for conveying characteristics of nonlinear distortion introduced by a transmitter to a receiver.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

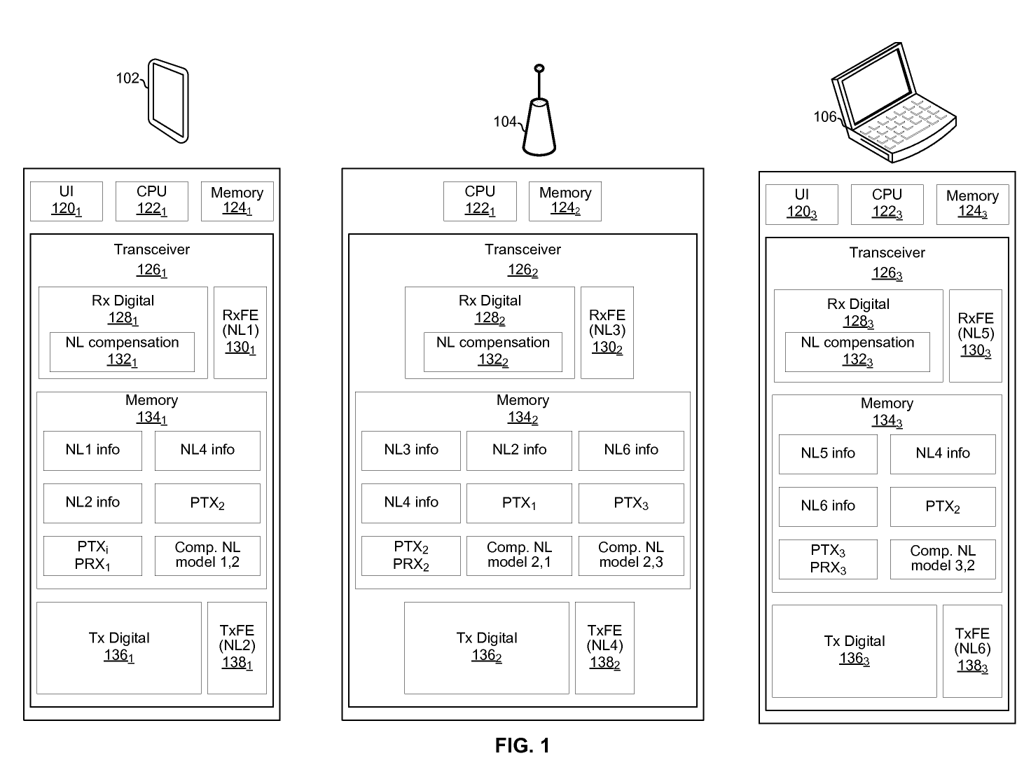

FIG. 1 is a diagram illustrating communication devices operable to perform nonlinearity estimation/replication for processing of received signals. Shown are user equipment devices (UEs) 102 and 106 and access point device (AP) 104. Each of the UEs 102 and 106 may be, for example, a smartphone, a tablet computer, a laptop computer, a router, a network switch, a network gateway, or the like. The AP 104 may be, for example, a cellular base station, an 802.11 compatible access point, and/or the like. In some instances, the AP 104 may be the same device as a UE device but configured into an access point mode.

Each of the devices 102 and 106 comprises user interface circuitry 120 (e.g., touchscreen, buttons, speakers, etc. and their associated drivers), CPU 122, system memory 124 (e.g., flash, DRAM, SRAM, ROM, HDD, and/or the like), and a transceiver 126. Each transceiver 126 comprises receiver digital circuitry 128, receiver analog front-end circuitry (RxFE) 130, transmitter digital circuitry 136, transmitter analog front-end circuitry (TxFE) 138, and memory 134. In the example shown, the AP 104 comprises all of the above, except for user interface circuitry.

Each RxFE 130ᵢ may introduce nonlinear distortion to signals it receives. Characteristics of the nonlinear distortion introduced by the RxFE 130ᵢ may be stored in memory 134ᵢ. The characteristics of the nonlinear distortion may be generated during testing (e.g., certification testing) of the transceiver 126ᵢ and/or of the device (e.g., 102, 104, or 106) in which it resides. The characteristics of the nonlinear distortion may be stored to the memory 134ᵢ during production of the transceiver 126ᵢ and/or of the device in which it resides. The characteristics of the nonlinear distortion may include, for example, an indication of one or more nonlinear distortion model types (e.g., AM/AM model type, AM/PM model type, memory-less polynomial model type, memory (full) polynomial model type, Volterra, Rapp, and/or phase noise parametric model) that are most suitable for estimating/reproducing the nonlinear distortion introduced by the RxFE 130ᵢ. An indication of the model type may comprise, for example, an identification of parameters to use for estimating/replicating distortion introduced by the power amplifier. An indication of the model type may comprise, for example, a supplier, part number, and/or other identifier of the power amplifier. Upon identifying the power amplifier, the receiver could then, for example, query a network database that stores nonlinear distortion model types and/or nonlinear distortion model parameters to use for various power amplifiers. Each model type may be defined by one or more parameters. For example, where both amplitude and phase distortion depend on instantaneous signal power, a combined AM/AM and AM/PM type nonlinear distortion model may be used. Such a model may be characterized by a signal power parameter, one or more amplitude-to-amplitude (AM/AM) distortion parameters, and one or more amplitude-to-phase (AM/PM) distortion parameters. Such a model may be realized by, for example, a look-up table (LUT) that maps a signal power parameter to a complex value that represents the AM/AM and AM/PM parameters. The characteristics of the nonlinear distortion about the nonlinear distortion introduced by the RxFE 130ᵢ may include recommended values to use for the parameters of a nonlinear distortion model. The recommended values may be average values or nominal values, for example. Different values may, for example, be recommended based on different gain/sensitivity settings. A present receiver gain/sensitivity setting PRXᵢ may also be stored in the memory 134ᵢ.

Each TxFE 138ᵢ may introduce nonlinear distortion to signals it transmits. Characteristics of the nonlinear distortion introduced by the TxFE 138ᵢ may be stored in memory 134ᵢ. The characteristics of the nonlinear distortion may be generated during testing (e.g., certification testing) of the transceiver 126ᵢ and/or of the device (e.g., 102, 104, or 106) in which it resides. The characteristics of the nonlinear distortion introduced by the TxFE 138ᵢ may be stored to the memory 134ᵢ during production of the transceiver 126ᵢ and/or of the device in which it resides. For example, the characteristics of the nonlinear distortion introduced by the TxFE 138ᵢ may be generated and stored to the memory 134ᵢ during power up of the transceiver 126ᵢ using a loop back mode in which the transceiver 126ᵢ receives its own transmission. The stored characteristics of the nonlinear distortion introduced by the TxFE 138ᵢ may be sent to a communication partner, as discussed further below. Similarly, as discussed below, characteristics of the nonlinear distortion introduced by a communication partner may be received from the communication partner and stored in the memory 134ᵢ. The stored characteristics of the nonlinear distortion introduced by the TxFE 138ᵢ may be used for digital pre-distortion in the transceiver 126i. The stored characteristics of the nonlinear distortion introduced by the TxFE 138ᵢ may include, for example, an indication of one or more nonlinear distortion model types (e.g., AM/AM model type, AM/PM model type, memory-less polynomial model type, memory (full) polynomial model type, Volterra, and/or Rapp) that are most suitable for modeling the nonlinear distortion introduced by the TxFE 138ᵢ. Each model type may be defined by one or more parameters. An indication of the model type may comprise, for example, an identification of parameters to use for estimating/replicating distortion introduced by the power amplifier. An indication of the model type may comprise, for example, a supplier, part number, and/or other identifier of the power amplifier. Upon identifying the power amplifier, the receiver could then, for example, query a network database that stores nonlinear distortion model types and/or nonlinear distortion model parameters to use for various power amplifiers. In an example implementation, the model for nonlinear distortion introduced by TxFE 138ᵢ may be communicated upon admission to the network of the device in which TxFE 138ᵢ resides. In an example implementation, the model for nonlinear distortion introduced by TxFE 138ᵢ may be acquired from dedicated signaling (e.g., preamble) that precedes payload transmission. In an example implementation, the model for nonlinear distortion introduced by TxFE 138ᵢ may be learned from dedicated signals sent upon receiver request or initiated (e.g., occasionally, periodically, or in response to some determined event) by the device in which TxFE 138ᵢ resides.

The characteristics of the nonlinear distortion introduced by the TxFE 138ᵢ may include recommended values to use for the parameters of a nonlinear distortion model. The recommended values may be average values or nominal values, for example. Different values may, for example, be recommended based on different gain/transmit power settings. A present transmit power setting PTXᵢ may also be stored in the memory 134ᵢ (the transmit power setting may convey characteristics such as, for example, bias point of the power amplifier, nominal output power of the power amplifier, a type and/or level of pre-distortion and/or other pre-compensation in use, etc.).

Each Rx digital circuitry 128ᵢ comprises nonlinear distortion compensation circuitry 132ᵢ. For a signal received from any particular transmitter, the nonlinear distortion compensation circuitry 132ᵢ is operable to use a composite nonlinear distortion model corresponding to that transmitter for processing the received signal. The composite nonlinear distortion model may be stored in the memory 134ᵢ. In an example implementation, the nonlinear distortion compensation circuitry 132ᵢ may use the corresponding composite nonlinear distortion model in a feedback loop by applying the nonlinear distortion model to a symbol (or symbol vector) decision and comparing the resulting signal to the received signal to generate an error signal. The nonlinear distortion compensation circuitry 132 may also be operable to train the composite nonlinear distortion model during operation such that the composite nonlinear distortion model tracks changes in the nonlinear distortion experienced by signals from the particular transmitter (e.g., as a result of the particular transmitter changing is transmit power). The training may comprise determining which nonlinear distortion model type and/or nonlinear distortion parameter values result in a model that can, with desired accuracy, estimate/replicate, nonlinear distortion introduced by said particular transmitter. That is, determine model type and/or parameter values that, when applied to an undistorted signal, result in a distorted signal that replicates, with desired accuracy, a distorted signal that would result from the undistorted signal passing through the system. As used herein, “training” of a composite nonlinear distortion model to be used for a particular transmitter may comprise determining the composite nonlinear distortion model from scratch (i.e., without starting from a previously determined composite nonlinear distortion model used for that particular transmitter) and/or updating a previously determined composite nonlinear distortion model corresponding to that particular transmitter (e.g., updating the parameter values of a composite nonlinear distortion model previously generated for the particular transmitter).

The memory 134ᵢ also stores nonlinear distortion characteristics for partner transceivers/devices with which the transceiver 126ᵢ communicates. For each partner device/transceiver, this may include characteristics of the nonlinear distortion introduced by TxFE and/or RxFE of the partner device/transceiver. Some or all of the characteristics of the nonlinear distortion may be transmitted by the partner device/transceiver during initial connection setup between the transceiver 126ᵢ and the partner device. Some of all of the characteristics of nonlinear distortion introduced by the partner device may be transmitted as part of a preamble at the beginning of each communication from the partner device to the transceiver 126ᵢ. The preamble may comprise a training signal field from which the nonlinearity model can be acquired without the model type and/or parameter values being communicated directly.

The transceiver 126ᵢ may measure the nonlinear distortion that a partner device/transceiver introduced during transmission (e.g., of a preamble and/or payload). The transceiver 126ᵢ may use this measurement to generate characteristics of the nonlinear distortion introduced by the partner device/transceiver (e.g., a model type and/or parameter values suited for representing distortion introduced by the partner device/transceiver. The transceiver 126ᵢ may use the characteristics of the nonlinear distortion introduced by the partner device for training the composite nonlinear distortion model used for receiving communications from the partner device. The transceiver 126ᵢ may also send the characteristics of the nonlinear distortion introduced by the partner device to the partner device/transceiver which originated the transmission, such that the partner device(s)/transceiver(s) can use the characteristics of the nonlinear distortion introduced by the partner device for configuring itself, etc.

The transceiver 126ᵢ may transmit, to each partner device/transceiver, characteristics of the nonlinear distortion introduced by its TxFE 138ᵢ and/or its RxFE 130ᵢ. For each partner device/transceiver, some or all of the characteristics of the nonlinear distortion introduced by its TxFE 138ᵢ and/or its RxFE 130ᵢ may be transmitted to that partner device/transceiver at the beginning of each communication burst from the transceiver 126ᵢ (e.g., as part of a preamble). The partner device may use the characteristics of the nonlinear distortion introduced by its TxFE 138ᵢ and/or its RxFE 130ᵢ for training the composite nonlinear distortion model it uses for processing communications received from, or to be transmitted to, the transceiver 126ᵢ.

FIG. 1 shows the devices 102, 104, and 106 after both UEs 102 and 106 have been associated with the AP 104.

Nonlinear distortion characteristics held in the memory 134₁ may include: characteristics of the nonlinear distortion introduced by RxFE 130₁ (“NL1 info”), characteristics of the nonlinear distortion introduced by TxFE 138₁ (“NL2 info”), its present transmit power setting (“PTX₁”) (which could also be considered a characteristic about the nonlinear distortion introduced by the TxFE 138₁), its present receive sensitivity setting (“PRX₁”) (which could also be considered a characteristic about the nonlinear distortion introduced by the RxFE 130₁), characteristics of the nonlinear distortion introduced by TxFE 138₂ (“NL4 info”), the most-recently received transmit power setting of TxFE 138₂ (“PTX₂”) (which could also be considered as a characteristic about the nonlinear distortion introduced by the TxFE 138₂), and/or the composite nonlinear distortion model used for receiving signals from transceiver 126₂ (“Comp. NL model 1,2”).

Similarly, nonlinear distortion characteristics held in the memory 134₃ may include: characteristics of the nonlinear distortion introduced by RxFE 130₃ (“NL5 info”), characteristics of the nonlinear distortion introduced by TxFE 138₃ (“NL6 info”), its present transmit power setting (“PTX₃”), its present receive sensitivity setting (“PRX₃”), characteristics of the nonlinear distortion introduced by TxFE 138₂ (“NL4 info”), the most-recently received transmit power setting of TxFE 138₂ (“PTX₂”), and/or the composite nonlinear distortion model used for receiving signals from transceiver 126₂ (“Comp. NL model 3,2”).

As for the memory 134₂, it may hold its own nonlinear distortion characteristics of its own nonlinear distortion and nonlinear distortion characteristics for both transceiver 126₁ and transceiver 126₃. That is, the memory 134₂ may, for example, hold: characteristics of the nonlinear distortion introduced by RxFE 130₂ (“NL3 info”), characteristics of the nonlinear distortion introduced by TxFE 138₂ (“NL4 info”), its present transmit power setting (“PTX₂”), its present receive sensitivity setting (“PRX₂”), characteristics of the nonlinear distortion introduced by TxFE 138₁ (“NL2 info”), the most-recently received transmit power setting of TxFE 138₁ (“PTX₁”), the composite nonlinear distortion model used for receiving signals from transceiver 126₁ (“Comp. NL model 2,1”), characteristics of the nonlinear distortion introduced by TxFE 138₃ (“NL6 info”), the most-recently received transmit power setting of TxFE 138₃ (“PTX₃”), and the composite nonlinear distortion model used for receiving signals from transceiver 126₃ (“Comp. NL model 2,3”).

For more complicated routing paths than the single-hop star topology of FIG. 1, a device such as 102, 104, or 106, may store/maintain nonlinear distortion characteristics for any (possibly all, depending on memory constraints) devices through which communications flow en route to that device. For example, if device 106 transmitted to device 102 and device 104 was simply a repeater, device 102 may store/maintain nonlinear distortion characteristics for both devices 106 and 104, and may use such characteristics for processing communications received from device 106 via device 104.

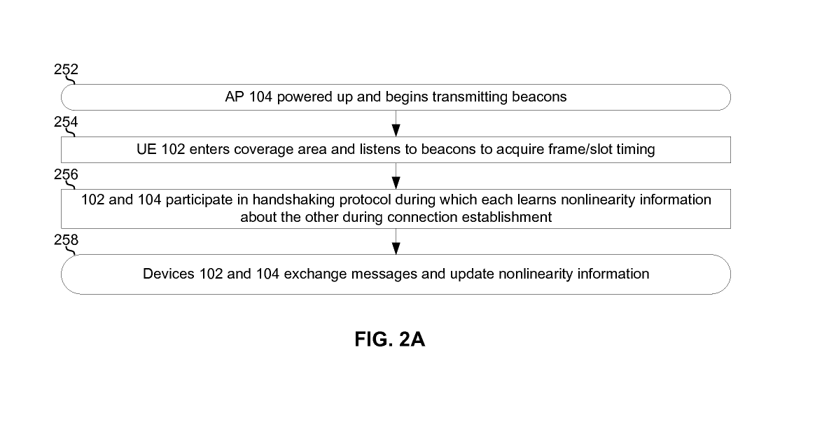

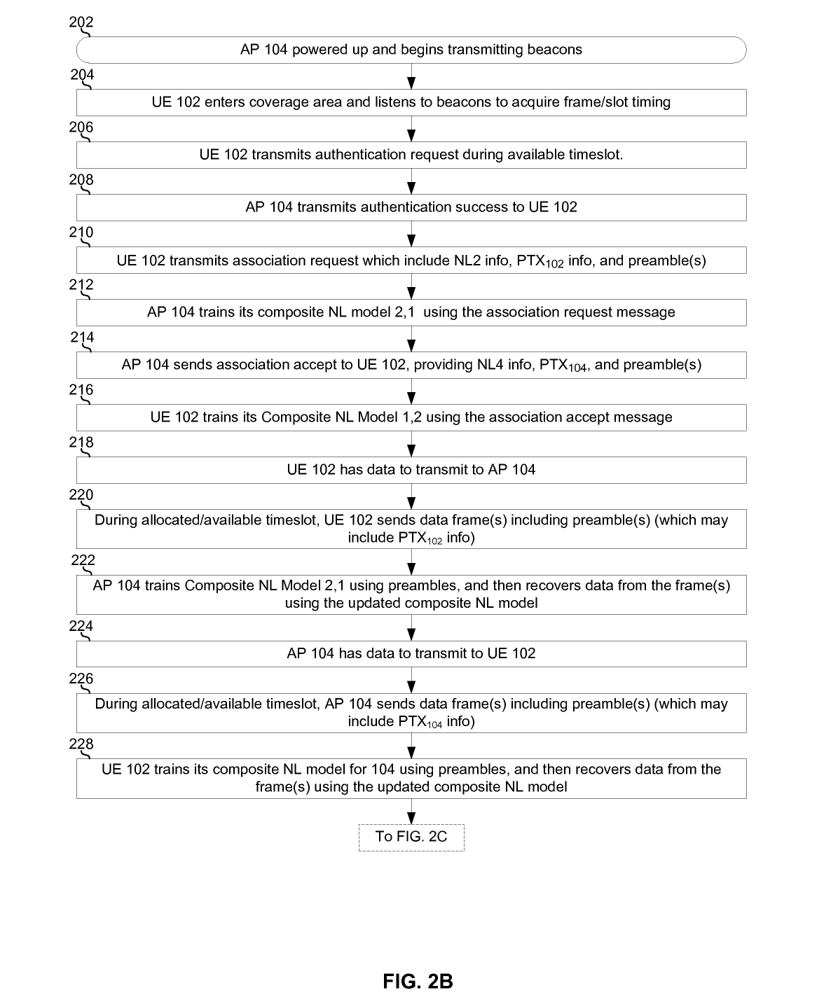

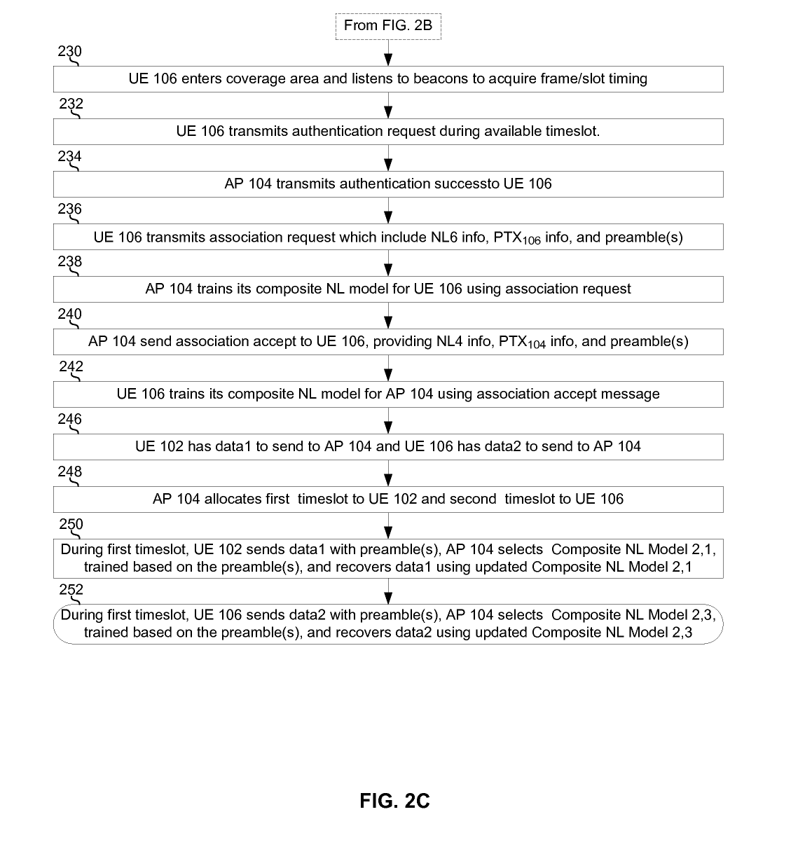

FIG. 2 shows a flowchart illustrating an example network admission and nonlinear distortion acquisition process used by the communication devices of FIG. 1.

The process begins with block 252 in which the AP 104 powers up and begins transmitting beacon frames. The beacons may be transmitted using low-order modulation, low symbol rate, low code rate, and/or other characteristic(s) that enable reliable reception of the beacon frames even in poor channel conditions.

In block 254, the UE 102 enters a coverage area and listens to beacons to acquire frame/slot timing. This may enable UE 102 to identify a channel and timeslot on which it can transmit an authentication request. For example, the beacon may identify periods which are available for unassociated devices to contend for channel access.

In block 256, the UE 102 and AP 104 participate in a handshaking protocol which may comprise the exchange of one or more messages for authentication, association, and/or the like. The handshaking protocol may also comprise the exchange of characteristics of nonlinear distortion introduced by the devices 102 and 104 and/or signals for training nonlinear distortion introduced by the devices 102 and 104. Thus, after the handshaking protocol is complete, a connection is established between the devices 102 and 104, and each has characteristics of the nonlinear distortion introduced by the other. The devices 102 and 104 may use these characteristics for processing signals received from, and/or transmitted to, the other.

In block 258, the UE 102 and AP 104 exchange messages. The nonlinear distortion characteristics obtained during block 256 may be used in processing the messages. Additionally, the stored nonlinear distortion characteristics may be trained based on nonlinear distortion training signals sent as part of the messages (e.g., as preambles) and/or as distinct training signals sent periodically and/or on an event-driven basis. In this regard, training may be carried out from time to time according to some predefined routine. For example, when direct connections are to exist between UE 102 and UE 106, and between AP 104 and UE 106, admission of the device 106 to the network may require training signals from UE 102 to UE 106, from UE 106 to UE 102, from AP 104 to UE 106, and from UE 106 to AP 104. Another example scenario in which training may be required is when the link conditions change (e.g., due to varying channel and/or noise conditions and regardless of the accuracy of the nonlinear distortion model), resulting in devices 102 and 104 switching to a different modulation/coding mode (e.g., decreasing the modulation order and/or FEC code rate). The new mode may involve different power amplifier settings. For example, lower constellations may tolerate higher nonlinear distortion and thus the power amplifiers may be operated closer to saturation, which may increase efficiency. Such a change in power amplifier settings may require, or benefit from, training of nonlinear distortion characteristics (since transmit power may have a large influence on the amount of nonlinear distortion introduced by a transmitter).

FIGS. 2B and 2C show a flowchart illustrating an example network admission and nonlinear distortion acquisition process used by the communication devices of FIG. 1. The blocks illustrated in FIGS. 2B and 2C are merely examples to illustrate. In other implementations, additional or fewer blocks may be present and/or the order of the blocks may be different.

The process begins with block 202 in which the AP 104 powers up and begins transmitting beacon frames. The beacons may be transmitted using low-order modulation, low symbol rate, low code rate, and/or other characteristic(s) that enable reliable reception of the beacon frames even in poor channel conditions.

In block 204, the UE 102 enters a coverage area and listens to beacons to acquire frame/slot timing. This may enable UE 102 to identify a channel and timeslot on which it can transmit an authentication request. For example, the beacon may identify periods which are available for unassociated devices to contend for channel access.

In block 206, the UE 102 transmits an authentication request during a determined timeslot.

In block 208, the AP 104 receives and processes the authentication request and, upon authenticating the device 102, transmits an authentication success message to the UE 102.

In block 210, the UE 102 transmits an association request which may include characteristics such as, for example, characteristics of the nonlinear distortion introduced by the TxFE 138₁ and/or RxFE 130₁, characteristics of the present and/or possible transmit power levels of the TxFE 138₁, and/or characteristics of the present and/or possible receive sensitivity levels of the RxFE 138₁. The association request may additionally, or alternatively, comprise deterministic symbols (i.e., symbols which a receiver can determine definitively based on a priori knowledge, such as knowledge of the symbols themselves or knowledge of a deterministic algorithm used to produce the symbols).

In block 212, the AP 104 trains the composite nonlinear distortion model it uses for communications with UE 102 (“Composite NL model 2,1”). The training uses the characteristics received in the association request message sent by the UE 102 in block 210, and/or uses the physical layer characteristics of the deterministic symbols of the association request message.

In block 214, the AP 104 sends an association accept message to UE 102. The association accept message may include characteristics about the AP 104 such as, for example, characteristics of the nonlinear distortion introduced by the TxFE 138₂ and/or RxFE 130₂, characteristics of the present and/or possible transmit power levels of the TxFE 138₂, and/or characteristics of the present and/or possible receive sensitivity levels of the RxFE 138₂. In an example implementation, some or all of these characteristics may additionally, or alternatively, be included in the beacons transmitted by the AP 104. The association accept message may additionally, or alternatively, comprise deterministic symbols (e.g., in the form of one or more preambles).

In block 216, the UE 102 trains the composite nonlinear distortion model it uses for communications with AP 104 (“Comp. NL model 1,2”). The training uses the association accept message sent by the AP 104 in block 214, and/or uses the physical layer characteristics of the deterministic symbols of the association accept message.

In block 218, the UE 102 has data to transmit to the AP 104.

In block 220, during an allocated/available timeslot, the UE 102 sends data frame(s) to the AP 104. The frame(s) may include preamble(s) ahead of the data. The preambles may be constructed to enable the AP 104 to train the Composite NL Model 2,1 prior to using the Composite NL Model 2,1 to demodulate/decode the data.

The preamble(s) may comprise deterministic symbols such that the transceiver 126₂ may use the physical layer characteristics of the received preamble(s) to train the Composite NL Model 2,1. Different portions of the preamble(s) may be sent at different transmit power levels which correspond to different amounts of nonlinear distortion introduced by the TxFE 138₁ (e.g., based on the power transfer function of a power amplifier of the TxFE 138₁). In an example implementation, a portion of the preamble(s) may be intentionally corrupted/distorted (e.g., sent with very high transmit power corresponding to a highly-compressed portion of the power transfer function) to provide characteristics of the nonlinear distortion introduced by the TxFE 138₁.

A portion of the preamble(s) may be sent at low-order modulation, low code rate, and/or with other characteristics that enable that portion to be demodulated even if the Composite NL model 2,1 is not accurately estimating/replicating the nonlinear distortion being introduced to the frame(s) by the UE 102. This portion of the preamble(s) may include, for example, a transmit power setting (value of PTX₁) with which the payload of the data frames was transmitted.

In block 222, the AP 104 trains the Composite NL Model 2,1 using the preamble(s), and then recovers data from the frame(s) using the updated Composite NL Model 2,1.

In block 224, the AP 104 has data to transmit to the UE 102.

In block 226, during an allocated/available timeslot, the AP 104 sends data frame(s) to the UE 102. The frame(s) may include preamble(s) ahead of the data. The preambles may be constructed to enable the UE 102 to train its Composite NL Model 1,2 prior to using the Composite NL Model 1,2 to demodulate/decode the data.

The preamble(s) may comprise deterministic symbols such that the transceiver 126₁ may use the physical layer characteristics of the received preamble(s) to train the Composite NL Model 1,2. Different portions of the preamble(s) may be sent at different transmit power levels which correspond to different amounts of nonlinear distortion introduced by the TxFE 138₂ (e.g., based on the power transfer function of a power amplifier of the TxFE 138₂). In an example implementation, a portion of the preamble(s) may be intentionally corrupted/distorted (e.g., sent with very high transmit power corresponding to a highly-compressed portion of the power transfer function) to provide characteristics of the nonlinear distortion introduced by the TxFE 138₂.

A portion of the preamble(s) may be sent at low-order modulation, low code rate, and/or with other characteristics that enable that portion to be demodulated even if the Composite NL Model 1,2 is not accurately estimating/replicating the nonlinear distortion being introduced to the frame(s) by the AP 104. This portion of the preamble(s) may include, for example, a transmit power setting (value of PTX₂) with which the payload of the data frames was transmitted.

In block 228, the UE 102 trains the Composite NL Model 1,2 using the preamble(s), and then recovers data from the frame(s) using the updated Composite NL Model 1,2.

Now referring to FIG. 2C, in blocks 230 through 242 the UE 106 associates with the AP 104 in the same manner as UE 102 did in blocks 204 through 216.

In block 246, the UE 102 has data (“data1”) to send to AP 104 and UE 106 has data (“data2”) to send to the AP 104.

In block 248, the AP 104 allocates a first timeslot to UE 102 and allocates a second timeslot (e.g., the next timeslot immediately following the first timeslot) to UE 106.

In block 250, during the first timeslot, UE 102 sends data1 preceded by one more preambles. The AP 104 selects Composite NL Model 2,1, trains it based on preamble(s) appended to data1, and recovers data1 using updated Composite NL Model 2,1.

In block 252, during the second timeslot, UE 106 sends data2 preceded by one more preambles. The AP 104 selects Composite NL Model 2,3, trains it based on preamble(s) appended to data1, and recovers data2 using updated Composite NL Model 2,3.

In FIGS. 2B and 2C, characteristics of nonlinear distortion introduced by a particular device/transceiver are maintained between bursts of communication with that particular device/transceiver. That is, for example, AP 104 stores NL1 info, NL2 info, PTX₁, PRX₁, and Comp. NL model 2,1, even after a burst of communication with device 102 is complete and the AP 104 has moved on to communicating with device 106. In this manner, in the example of FIGS. 2B and 2C, any of NL1 info, NL2 info, PTX₁, PRX₁, and Comp. NL model 2,1 only needs to be updated, rather than learned from scratch, at the beginning of a new burst of communication with device 102. In another embodiment, however, nonlinear distortion characteristics for a particular partner device/transceiver may not be retained between bursts of communication with that transceiver. Rather, the nonlinear distortion characteristics may be learned from scratch at the beginning of each communication burst. That is, for example, any or all of NL1 info, NL2 info, PTX₁, PRX₁, and Comp. NL model 2,1 may be learned from scratch at the beginning of each communication burst with device 102 (e.g., using preamble(s)).

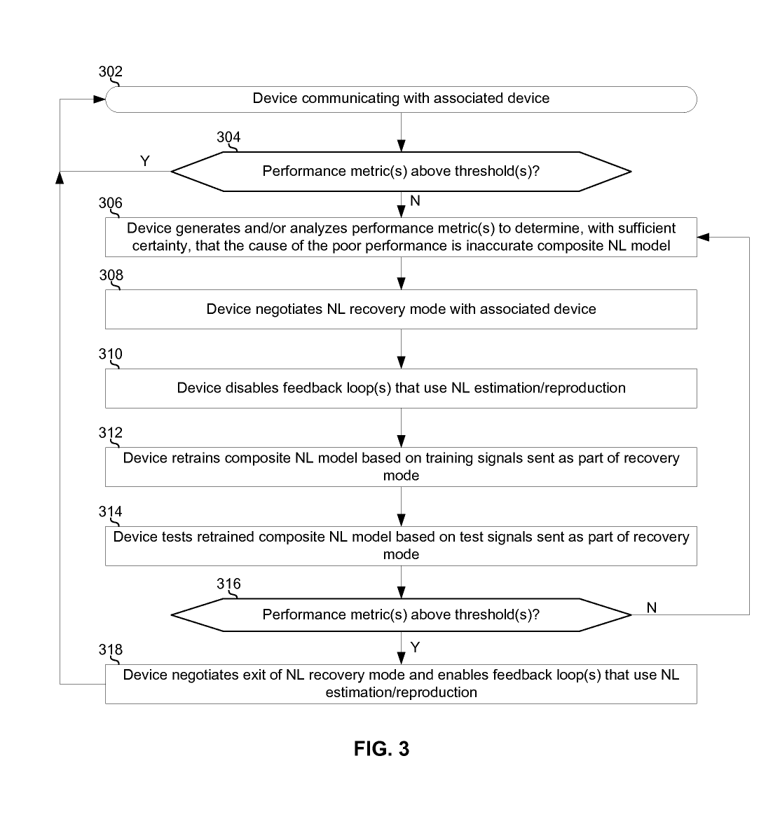

FIG. 3 shows a flowchart illustrating an example process performed by devices operable to perform nonlinear distortion estimation/replication for processing of received signals. The process begins with block 302.

In block 302, a device (e.g., UE 102) is communicating with an associated device (e.g., AP 104).

In block 304, the device determines whether one or more performance metrics (e.g., symbol error rate, bit error rate, packet error rate, signal to noise ratio, and/or the like) fall above (or below, as the case may be) a required/desired threshold(s). If so, then the process returns to block 302.

Returning to block 304, if the performance metric(s) do not fall above (or below, as the case may be) the threshold(s), then the process advances to block 306.

In block 306, the device analyzes one or more performance metrics to determine, with sufficient certainty, that the cause of the poor performance is that the composite nonlinear distortion model used for receiving communications from the associated device is not accurately estimating/replicating the nonlinear distortion. The metric(s) analyzed in block 306 may be the same metric(s) used in block 304 and/or may be different metric(s) calculated for the analysis.

In an example implementation, a metric used for isolating an inaccurate composite nonlinear distortion model may be mean-square-error (MSE) vs. received signal power (and/or vs. transmitted signal power, if known). This metric may be useful in isolating the composite nonlinear distortion model as inaccurate because relatively low transmit power (which may correspond to relatively low received power, all else being equal) may correspond to relatively low nonlinear distortion (i.e., such transmissions occur on the linear portion of the power amplifier power transfer characteristic), and relatively high transmit power (which may correspond to relatively high received power, all else being equal) may correspond to relatively high nonlinear distortion (i.e., such transmissions occur on the compressed portion of the power amplifier power transfer characteristic). If the MSE vs. power shows good performance at lower power and poor performance at high power, this may be used (possibly in combination with other performance metrics) as an indication that the composite nonlinear distortion model is inaccurate. Another example metric is the MSE of the received signal vs. the expected signal reproduced from the estimated symbols and the estimated channel estimate.

In block 308, the device negotiates with the associated device to enter a nonlinear distortion recovery mode. Such a mode may, for example, correspond to the associated device reducing modulation order, code rate, and/or other signaling characteristics of signals transmitted to enable at least a lower throughput (i.e., to gracefully degrade performance rather than catastrophic failure) and may also correspond to the associated device sending signals to aid in training the composite nonlinear distortion model. In an example implementation, there may be multiple recovery modes. The initial mode or modes may be least disruptive to system performance. For example, a first mode of recovery may comprise a request for an extended preamble (or other additional or “longer” training signal) that may have little or no impact on the overall throughput (e.g., may introduce an imperceptible latency or tolerable buffering penalty). If the initial recovery modes are unsuccessful subsequent recovery modes may have an increasing impact on latency until a point is reached where the latency is no longer tolerable (e.g., from a user perspective or a buffering/memory space perspective). At such a point, the recovery may then proceed to block 310.

In block 310, the device disables use of the composite nonlinear distortion model for processing data from the associated device. For example, one or more feedback loops that make use of the composite nonlinear distortion model may be configured so as to have no impact on data symbol decisions while training takes place.

In block 312, the device trains the composite nonlinear distortion model using training signals sent as part of the nonlinear distortion recovery mode. Such signals may include characteristics of nonlinear distortion introduced by the associated device, characteristics of present and/or possible transmit power settings of the associated device, preambles having intentional and known nonlinear distortion, and/or the like.

In block 314, the device tests the trained composite nonlinear distortion model using test signals sent as part of the nonlinear distortion recovery mode. For example, a sequence of predetermined signals having predetermined nonlinear distortion may be sent and the device may use the trained composite nonlinear distortion model to recover symbols or bits in the predetermined signals.

In block 316, it is determined whether performance metric(s) for the test signals is above (or below, as the case may be) a required/desired threshold(s). If not, the process returns to block 306. If so, the process advances to block 318.

In block 318, the device and associated device negotiate exit of nonlinear distortion recovery mode and the device re-enables use of the composite nonlinear distortion model for reception of signals from the associated device.

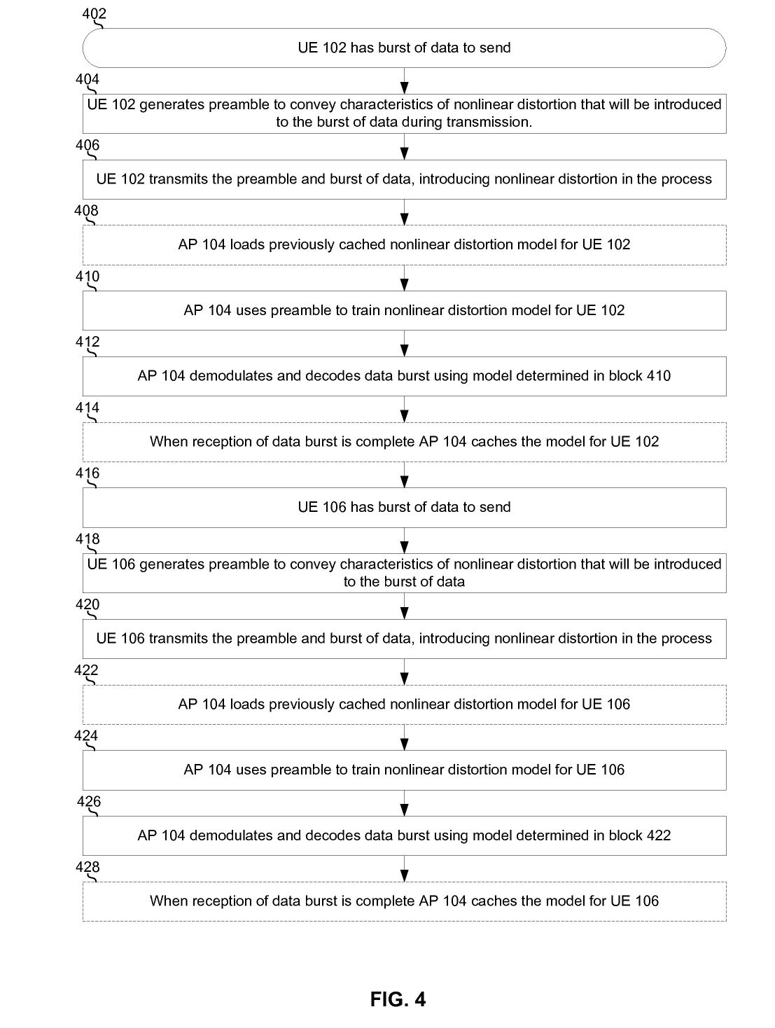

FIG. 4 is a flowchart illustrating example operations in which nonlinear distortion models are trained on a per-burst basis using preambles of the data bursts.

In block 402, UE 102 has a burst of data to send to AP 104. In block 404, UE 102 generates a preamble for conveying characteristics of nonlinear distortion that will be introduced to the burst of data during transmission. In block 402, the UE 102 transmits the preamble and the burst of data. The data is nonlinearly distorted in the process of transmission.

In an example implementation, block 408 follows block 406. In such an implementation, upon detecting, or in anticipation of, a communication from UE 102, the AP 104 loads a nonlinear distortion model previously determined for UE 102. In such an implementation, training of the model based on the preamble sent in block 406 may be an update/refinement of the cached model. In another example implementation, block 408 may be absent and the process may proceed from block 406 to block 410. In such an implementation, training of the model may be done “from scratch” for each preamble.

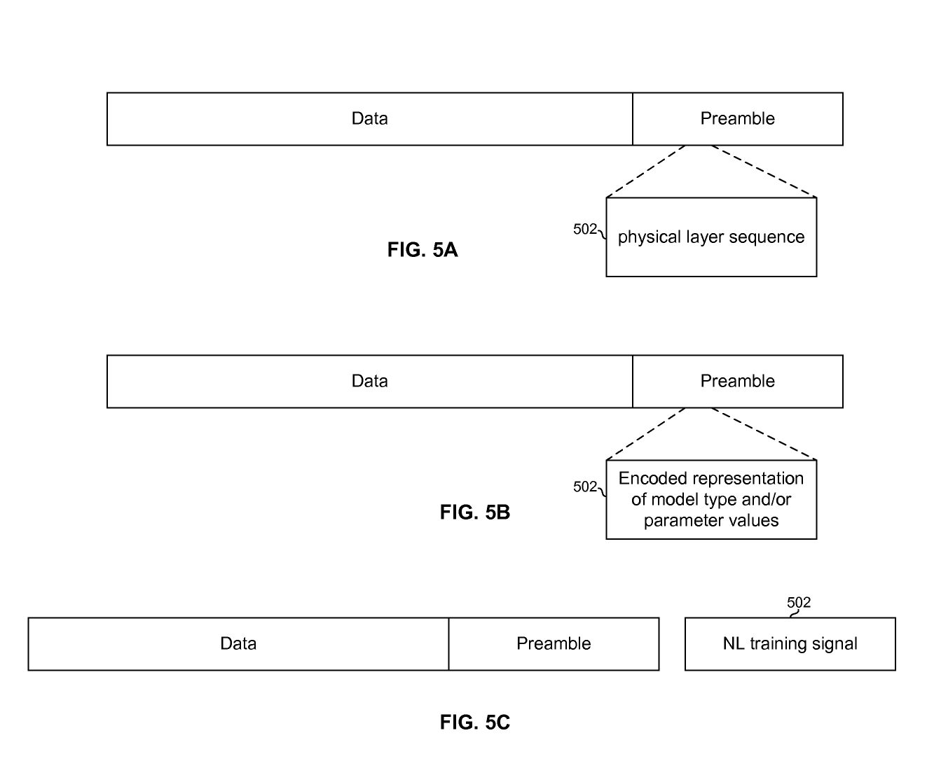

In block 410, the AP 104 uses the preamble to train a nonlinear distortion model for UE 102. In an example implementation in which a preamble such as shown in FIG. 5A is used, this may comprise processing the physical layer training signal field to determine the distortion that was introduced to it by the UE 102. In an example implementation in which a permeable such as shown in FIG. 5B is used, this may comprise demodulating/decoding the direct representation of the model type and/or parameters in the preamble.

In block 412, the AP 104 demodulates and decodes the data burst using the model trained in block 410.

In an example implementation, block 414 follows block 406. In such an implementation, upon completion of processing the data burst, the model trained in block 410 is cached (written to memory). In another example implementation, block 414 may be absent and the process may proceed from block 412 to block 416. In such an implementation, the model trained in block 410 may simply be discarded.

In block 416, UE 106 has a burst of data to send to AP 104. In block 418, UE 106 generates a preamble for conveying characteristics of nonlinear distortion that will be introduced to the burst of data during transmission. In block 420, the UE 106 transmits the preamble and the burst of data. The data is nonlinearly distorted in the process of transmission.

In an example implementation, block 422 follows block 420. In such an implementation, upon detecting, or in anticipation of, a communication from UE 106, the AP 104 loads a nonlinear distortion model previously determined for UE 106. In such an implementation, training of the model based on the preamble sent in block 420 may be an update/refinement of the cached model. In another example implementation, block 408 may be absent and the process may proceed from block 420 to block 424. In such an implementation, training of the model may be done “from scratch” for each preamble.

In block 424, the AP 104 uses the preamble to train a nonlinear distortion model for UE 106. In an example implementation in which a preamble such as shown in FIG. 5A is used, this may comprise processing the physical layer training signal field to determine the distortion that was introduced to it by the UE 106. In an example implementation in which a permeable such as shown in FIG. 5B is used, this may comprise demodulating/decoding the direct representation of the model type and/or parameters in the preamble.

In block 426, the AP 104 demodulates and decodes the data burst using the model trained in block 424.

In an example implementation, block 428 follows block 426. In such an implementation, upon completion of processing the data burst, the model trained in block 424 is cached (written to memory). In another example implementation, block 428 may be absent. In such an implementation, the model trained in block 424 may simply be discarded.

FIGS. 5A-5C illustrate example formats for a nonlinear distortion model trainings signal which conveys characteristics of nonlinear distortion introduced by a transmitter. In FIGS. 5A and 5B the nonlinear distortion model training signal 402 is transmitted as part of a preamble of a data burst. In FIG. 5C it is transmitted ahead of the preamble. In such an implementation, the nonlinear distortion model training signal may be a separate signal or may be second preamble, or preamble extension.

In FIG. 5A the nonlinear distortion model training signal comprises a physical layer sequence that does not directly represent the nonlinear distortion information. This physical layer sequence may comprise, for example, a deterministic series of symbols selected for its ability to exhibit the distortion introduced by the transmitter. The series may, for example, be fixed for all transmitters, fixed for a particular transmitter, or vary for a particular transmitter based on a variety of parameters such as, for example, the particular data to be transmitted, current noise conditions, current battery/power state, characteristics of a receiver to which a communications is destined, and/or the like. Where the sequence varies, it may do so according to a deterministic algorithm known to the receiver such that the receiver can correctly interpret the field. In an example implementation, the preamble may comprise additional fields for channel estimation/equalizer training/etc. and/or the nonlinear distortion training signal may be used by the receiver for such purposes.

In FIG. 5B, the nonlinear distortion model training sequence comprises a direct representation of a model type and/or model parameter values suited for modeling the nonlinear distortion introduced by the transmitter. For example, the preamble may comprise a bit or symbol map where, for example, a first one or more bits or symbols (or portion thereof) corresponds to a first model type and/or parameter value, a second one or more bits or symbols (or portion thereof) corresponds to a second model type and/or parameter value, and so on. In an example implementation, the preamble may comprise additional fields for channel estimation/equalizer training/etc. and/or the nonlinear distortion training field may be used for such purposes in the receiver.

In accordance with an example implementation of this disclosure, circuitry (e.g., 136₁ and 138₁) of an electronic transmitter may determine characteristics of nonlinear distortion introduced by the electronic transmitter during transmission of electronic signals onto a communication medium, and transmit a nonlinear distortion model training signal, from which the characteristics of the nonlinear distortion can be recovered, prior to transmitting data onto the communication medium. The circuitry may transmit the training signal as part of a preamble of each burst of data transmitted by the circuitry of the electronic transmitter. The circuitry may transmit the training signal as part of a handshaking protocol used for admission of the electronic transmitter to a network. The circuitry may transmit the training signal in response to a request from receiver (e.g., AP 104). The characteristics of the nonlinear distortion comprise an indication of a type of nonlinear distortion model suited for replicating the nonlinear distortion introduced by the electronic transmitter. The characteristics of the nonlinear distortion may comprise values to be used for parameters of a nonlinear distortion model tasked with replicating the nonlinear distortion introduced by the electronic transmitter. The parameters of the nonlinear distortion model comprise one or both of an amplitude-to-amplitude distortion parameter and an amplitude-to-phase distortion parameter. The parameter values may be in the form of a table indexed by a signal power parameter. The characteristics of the nonlinear distortion may comprise an identifier (e.g., supplier name, part number, classification and/or certification number from a certifying body, and/or the like) of a power amplifier of the electronic transmitter. The characteristics of the nonlinear distortion may comprise a power transfer characteristics of a power amplifier of the electronic transmitter.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method comprising:
performing by circuitry of an electronic transmitter:
determining characteristics of nonlinear distortion introduced by said electronic transmitter during transmission of electronic signals onto a communication medium; and
transmitting a nonlinear distortion model training signal onto said communication medium prior to transmitting data onto said communication medium, wherein said characteristics of said nonlinear distortion are recoverable from said training signal.

2. The method of claim 1, comprising transmitting said nonlinear distortion model training signal as part of a preamble of each burst of data transmitted by said circuitry of said electronic transmitter.

3. The method of claim 1, wherein said nonlinear distortion model training signal comprises a direct representation of said characteristics of said nonlinear distortion.

4. The method of claim 1, wherein said nonlinear distortion model training signal comprises a deterministic sequence of bits or symbols.

5. The method of claim 1, comprising transmitting said nonlinear distortion model training signal as part of a handshaking protocol used for admission of said electronic transmitter to a network.

6. The method of claim 1, comprising transmitting said nonlinear distortion model training signal in response to a request from receiver.

7. The method of claim 1, wherein said characteristics of said nonlinear distortion comprise an indication of a type of nonlinear distortion model suited for replicating said nonlinear distortion introduced by said electronic transmitter wherein said type is one of the following types: AM/AM, AM/PM, memory-less polynomial, memory (full) polynomial, Volterra, Rapp, and phase noise parametric.

8. The method of claim 1, wherein said characteristics of said nonlinear distortion comprise values to be used for parameters of a nonlinear distortion model tasked with replicating said nonlinear distortion introduced by said electronic transmitter.

9. The method of claim 8, wherein said parameters of said nonlinear distortion model comprise one or both of an amplitude-to-amplitude distortion parameter and an amplitude-to-phase distortion parameter.

10. The method of claim 8, wherein said values are in the form of a table indexed by a signal power parameter.

11. The method of claim 1, wherein said characteristics of said nonlinear distortion comprise an identifier of a power amplifier of said electronic transmitter.

12. The method of claim 1, wherein said characteristics of said nonlinear distortion comprise a power transfer characteristic of a power amplifier of said electronic transmitter.

13. A system comprising:
circuitry of an electronic transmitter operable to:
determine characteristics of nonlinear distortion introduced by said electronic transmitter during transmission of electronic signals onto a communication medium; and
transmit a nonlinear distortion model training signal onto said communication prior to transmission of data onto said communication medium, wherein said characteristics of said nonlinear distortion are recoverable from said training signal.

14. The system of claim 13, wherein said circuitry of said electronic transmitter is operable to transmit said nonlinear distortion model training signal as part of a preamble of each burst of data transmitted by said circuitry of said electronic transmitter.

15. The system of claim 13, wherein said nonlinear distortion model training signal comprises a direct representation of said characteristics of said nonlinear distortion.

16. The system of claim 13, wherein said nonlinear distortion model training signal comprises a deterministic sequence of bits or symbols.

17. The system of claim 13, wherein said circuitry of said electronic transmitter is operable to transmit said nonlinear distortion model training signal as part of a handshaking protocol used for admission of said electronic transmitter to a network.

18. The system of claim 13, wherein said circuitry of said electronic transmitter is operable to transmit said nonlinear distortion model training signal in response to a request from receiver.

19. The system of claim 13, wherein said characteristics of said nonlinear distortion comprise an indication of a type of nonlinear distortion model suited for replicating said nonlinear distortion introduced by said electronic transmitter wherein said type is one of the following types: AM/AM, AM/PM, memory-less polynomial, memory (full) polynomial, Volterra, Rapp, and phase noise parametric.

20. The system of claim 13, wherein said characteristics of said nonlinear distortion comprise values to be used for parameters of a nonlinear distortion model tasked with replicating said nonlinear distortion introduced by said electronic transmitter.

21. The system of claim 20, wherein said parameters of said nonlinear distortion model comprise one or both of an amplitude-to-amplitude distortion parameter and an amplitude-to-phase distortion parameter.

22. The system of claim 20, wherein said values are in the form of a table indexed by a signal power parameter.

23. The system of claim 13, wherein said characteristics of said nonlinear distortion comprise an identifier of a power amplifier of said electronic transmitter.

24. The system of claim 13, wherein said characteristics of said nonlinear distortion comprise a power transfer characteristic of a power amplifier of said electronic transmitter.
